(19) United States
(12) Patent Application Publication
(10) Pub. No.: US 2015/0237059 A1
(43) Pub. Date: Aug. 20, 2015

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Koji AOKI, Kanagawa (JP)

(73) Assignee: FUJI XEROX CO., LTD., Tokyo (JP)

(21) Appl. No.: 14/467,776

(22) Filed: Aug. 25, 2014

(30) Foreign Application Priority Data
Feb. 17, 2014 (JP) 2014-027543

(51) Int. Cl. H04L 29/06

(52) U.S. Cl. CPC H04L 63/1416; H04L 63/1441

(57) ABSTRACT

An information processing apparatus includes a detector that detects an attack performed via a communication line, and a changing unit that changes a current attacked address of the information processing apparatus to an address different from the current attacked address if the attack is detected by the detector.

### CROSS-REFERENCE TO RELATED APPLICATIONS

This application is based on and claims priority under 35 USC 119 from Japanese Patent Application No. 2014-027543 filed Feb. 17, 2014.

### BACKGROUND

### Technical Field

The present invention relates to an information processing apparatus, an information processing method, and a non-transitory computer readable medium.

### SUMMARY

According to an aspect of the invention, there is provided an information processing apparatus including a detector that detects an attack performed via a communication line, and a changing unit that changes a current attacked address of the information processing apparatus to an address different from the current attacked address if the attack is detected by the detector.

### BRIEF DESCRIPTION OF THE DRAWINGS

Exemplary embodiments of the present invention will be described in detail based on the following figures, wherein:

FIG. 1 is a conceptual module configuration diagram illustrating an example of the configuration of a first exemplary embodiment;

FIG. 2 illustrates an example of the system configuration to which the first exemplary embodiment is applied;

FIG. 3 is a flowchart illustrating an example of a process according to the first exemplary embodiment;

FIG. 4 is a flowchart illustrating an example of a process according to the first exemplary embodiment;

FIG. 5 is a conceptual module configuration diagram illustrating an example of the configuration of a second exemplary embodiment;

FIG. 6 is a flowchart illustrating an example of a process according to the second exemplary embodiment;

FIG. 7 illustrates an example of the data structure of an address blacklist;

FIG. 8 illustrates an example of the data structure of an address blacklist (netmask);

FIG. 9 illustrates an example of the data structure of an attacked address advertisement packet (ICMPv6 proprietary extension);

FIG. 10 illustrates an example of the data structure of an attacked address advertisement packet (ICMPv6 proprietary extension); and

FIG. 11 is a block diagram illustrating an example of the hardware configuration of a computer that realizes the exemplary embodiments.

### DETAILED DESCRIPTION

Hereinafter, exemplary embodiments of the present invention will be described in detail with reference to the accompanying drawings.

### First Exemplary Embodiment

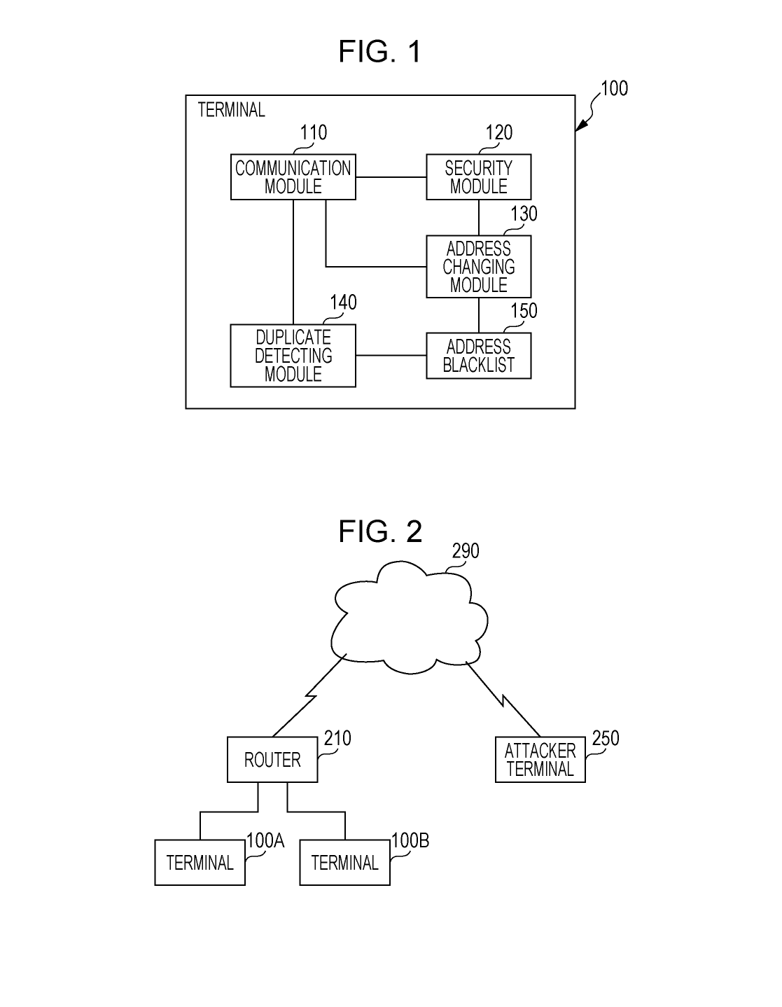

FIG. 1 is a conceptual module configuration diagram illustrating an example of the configuration of a first exemplary embodiment.

The term “module” generally refers to a logically separable part of software (a computer program), hardware, or the like. Accordingly, the term “module” as used in this exemplary embodiment refers not only to a module in a computer program but also to a module in a hardware configuration. Thus, this exemplary embodiment will be described in the context of a computer program for causing a computer to function as such modules (a program for causing a computer to execute individual procedures, a program for causing a computer to function as individual units, and a program for causing a computer to realize individual functions), a system, and a method. While “storing”, “being stored”, and equivalent terms are used for the convenience of description, such terms indicate, when the exemplary embodiment relates to a computer program, storing the computer program in a storage device or performing control such that the computer program is stored in a storage device. Modules may have a one-to-one correspondence with functions. In terms of implementation, however, a single module may be constituted by a single program, or multiple modules may be constituted by a single program. Conversely, a single module may be constituted by multiple programs. Also, multiple modules may be executed by a single computer, or a single module may be executed by multiple computers in a distributed or parallel environment. A single module may include another module. Furthermore, the term “connection” as used herein refers not only to physical connection but also to logical connection (such as exchanging data, issuing instructions, and cross-referring to data). The term “predetermined” means being determined before a certain process. This term includes the meaning of being determined before a certain process in accordance with a present situation or state or in accordance with a previous situation or state, before an operation of this exemplary embodiment is started, or even after an operation of this exemplary embodiment is started. If there are plural “predetermined values”, these values may differ from each other, or two or more (or all) of these values may be equal to each other. The expression “if A, do B” is used to indicate that “determine whether A is true, and do B if A is true”. However, this does not apply when a determination of whether A is true is not required.

Further, a system or an apparatus may be realized by multiple computers, hardware units, devices, or the like that are connected to each other via a communication medium, such as a network (including communication connection having a one-to-one correspondence), or may be realized by a single computer, hardware unit, device, or the like. The terms “apparatus” and “system” are used synonymously. It is to be understood that the “system” does not include anything that is merely a man-made social “mechanism” (social system).

Further, desired information is read from a storage device for each process performed by a module or, if plural processes are performed within a module, for each of the plural processes. After the process is performed, the processing result is written into the storage device. Accordingly, reading from the storage device before the process and writing into the storage device after the process may not necessarily be described herein. Examples of storage devices used herein may include a hard disk, a random access memory (RAM), an external storage medium, a storage device connected via a communication line, and a register in a central processing unit (CPU).

A terminal 100 (an information processing apparatus) of the first exemplary embodiment is configured to perform communication via a communication line. As illustrated in the example of FIG. 1, the terminal 100 includes a communication module 110, a security module 120, an address changing module 130, a duplicate detecting module 140, and an address blacklist 150. This exemplary embodiment will be described with an example in which the Internet is used as the infrastructure for the communication line, and Internet Protocol Version 6 (IPv6) is basically used as a protocol. Further, an address is for identifying an information processing apparatus at the communication source or destination, and IP addresses are used as an example in the following description. The term “packet” refers to both a normal packet (a packet other than attack packets) and an attack packet. A normal packet and an attack packet are referred to by these names when the two need to be distinguished from each other. An attacked terminal is a terminal that is attacked. An attacked address is an IPv6 temporary address that is attacked. Attacked time is time when a terminal is attacked. A temporary address (an anonymous address) is, for example, an address defined in accordance with an Internet technical standard called “RFC3041”. A description of a temporary address is disclosed in “Privacy Extensions for Stateless Address Autoconfiguration in IPv6 (http://www5d.biglobe.ne.jp/%257estssk/rfc/rfc3041j.html)”, “Starting Network with IPv6 (6), IPv6 Anonymous Address (http://news.mynavi.jp/series/ipv6/006/index.html)”, and so on.

It is not necessary that all the terminals connected to the communication line are provided with the modules of the terminal 100. As long as an attacked terminal is provided with the modules of the terminal 100, it is possible to improve security for other terminals. If all the terminals are provided with the modules of the terminal 100, the entire security of those connected to the communication line is further improved.

An overview of this exemplary embodiment will be described. This description is intended to facilitate understanding of this exemplary embodiment.

In this exemplary embodiment, when an attack from the Internet is detected in an information processing apparatus (a terminal, a communication apparatus) provided with a security function such as antivirus and IPS, an IPv6 temporary address (an attacked address) is discarded and a new temporary address is acquired. When another terminal attempts to acquire the attacked address, an ICMPv6 neighbor advertisement is transmitted so as to prevent the other terminal from reusing the attacked address.

More specifically, when a third party attacks a terminal, the IP address of the terminal is changed, thereby preventing the attacked terminal from being continually attacked. “Continually attacking” is continually performing various attacks to the same IP address.

The attacked terminal (the terminal that is attacked) retains the attacked address having been used before the address change. Thus, when another terminal on the same network attempts to set the attacked address, the attacked terminal issues a Duplication Address Detection (DAD) so as to prevent the attacked address from being used by the other terminal. A DAD is generally for notifying of the use of an IP address. When a DAD is issued, other terminals become unable to use the specified IP address. This eliminates the need of learning MAC addresses. Further, this prevents other terminals from using an attacked address.

More specifically, in this exemplary embodiment, communication is performed using an IPv6 temporary address (anonymous address). When an attack is detected, an attacked address is discarded and a temporary address is acquired again. Then, the attacked address is registered in an address blacklist 150.

Further, when receiving a neighbor solicitation, which is transmitted from another terminal on the same network before the other terminal sets an IP address, a determination is made as to whether a target address included in a neighbor solicitation packet matches a currently set IP address or the attacked address included in the address blacklist 150.

If a match is found, a neighbor advertisement is transmitted to the other terminal. According to IPv6 specifications, the other terminal having received the neighbor advertisement does not set that address.

The communication module 110 is connected to the security module 120, the address changing module 130, and the duplicate detecting module 140. The communication module 110 includes a network interface, and receives and transmits packets.

The security module 120 is connected to the communication module 110 and the address changing module 130. The security module 120 detects an attack performed via the communication line. More specifically, the security module 120 detects an attack, using a firewall (FW), an intrusion prevention system (IPS), or the like. That is, the security module 120 acquires a packet from the communication module 110, and determines whether the packet is an attack packet. The determination here may be made using an existing method. If the packet is determined to be an attack packet, the security module 120 requests the address changing module 130 to change the temporary address.

The address changing module 130 is connected to the communication module 110, the security module 120, and the address blacklist 150. If the attack is detected by the security module 120, the address changing module 130 changes the current attacked address of the terminal 100 to an address different from the current attacked address. More specifically, upon receiving a request for an address change from the security module 120, the address changing module 130 changes the address in accordance with a temporary address system (for example, RFC3041 Internet technical standards). Further, the address changing module 130 performs control such that the attacked address is stored in the address blacklist 150. Further, the address changing module 130 may perform control such that the attacked address is stored in association with the attacked time in the address blacklist 150. In the case of storing an attacked time, a time period (a predetermined time period) during which the attacked time is retained in the address blacklist 150 is specified in advance. Thus, after the elapse of that time period from the attacked time, the attacked address may be removed from the address blacklist 150.

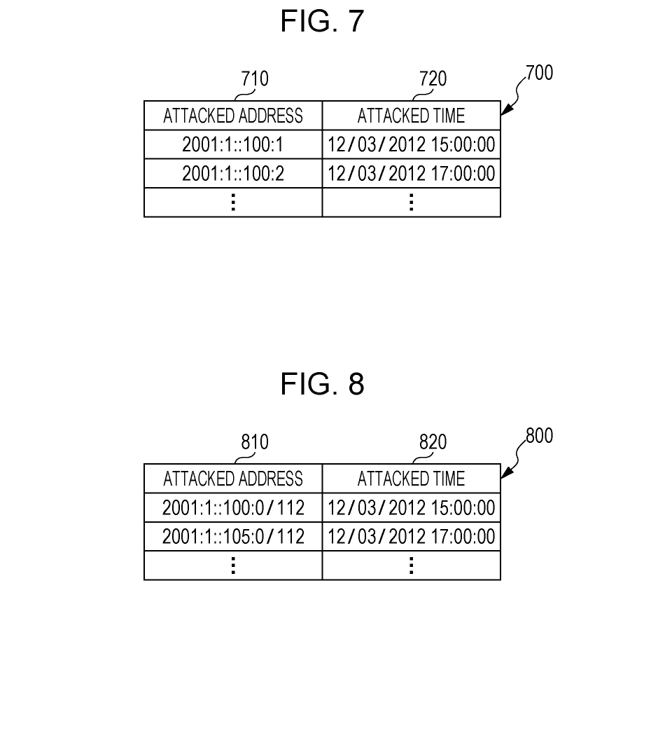

The address blacklist 150 is connected to the address changing module 130 and the duplicate detecting module 140. The address blacklist 150 stores an attack address. The address blacklist 150 is, for example, a table for storing a list of attacked addresses and attacked times. FIG. 7 illustrates an example of the data structure of an address blacklist 700 as a management table. The address blacklist 700 includes an attacked address field 710 and an attacked time field 720. The attacked address field 710 stores an attacked address. The attacked time field 720 stores a time (year, month, day, hour, minute, second, and fraction of a second, or a combination thereof) when the terminal 100 with the attacked address is attacked.

The address changing module 130 may mask the attacked address and then store the attacked address in the address blacklist 150. In this case, the duplicate detecting module 140 masks the requested address and determines whether the requested address matches the address stored in the address blacklist 150. Thus, DAD is performed also for addresses in the same range as the attacked address.

More specifically, when registering the attacked address in the address blacklist 150, the attacked address is stored with a netmask. For example, if the attacked address is “2001:1::100:1” and the netmask length (an arbitrary value) is 112 bits, “2001:1::100:0/112” is registered in the address blacklist 150. That is, the lower-order 16 bits of the address are registered as in the same range as addresses of the attacked address. Thus, the address is registered as in an address blacklist (netmask) 800 of the example of FIG. 8. FIG. 8 illustrates an example of the data structure of the address blacklist (netmask) 800. The address blacklist (netmask) 800 includes an attacked address field 810 and an attacked time field 820, and has the same structure as the address blacklist 700 of the example of FIG. 7. However, the attacked address field 810 stores a masked IP address.

The duplicate detecting module 140 performs the following processing. Upon receiving a neighbor solicitation for IP addresses in a range registered in the address blacklist 150 from another terminal 100, the duplicate detecting module 140 applies a netmask to a target address of a neighbor solicitation packet, and determines whether the calculated address is included in the address blacklist 150. If the calculated address is included in the address blacklist 150, the duplicate detecting module 140 transmits a neighbor advertisement.

For example, in the case where an attacker terminal 250 uses a method of attacking terminals while shifting the address of the attack target by one each time, the next address to be attacked is highly likely to be around the attacked address. That is, the risk of the address of a possible attack target being used by another terminal is effectively reduced.

Further, the duplicate detecting module 140 may transmit a neighbor advertisement together with a range of the attacked address, to the other terminal 100 via the communication module 110. Thus, an invalid address range (netmask length) is included in the neighbor advertisement.

More specifically, an attacked terminal receives a neighbor solicitation from another terminal. Then, if the target address of the neighbor solicitation is an attacked address, an invalid address range (netmask length) is attached to an option field of a neighbor advertisement to be transmitted.

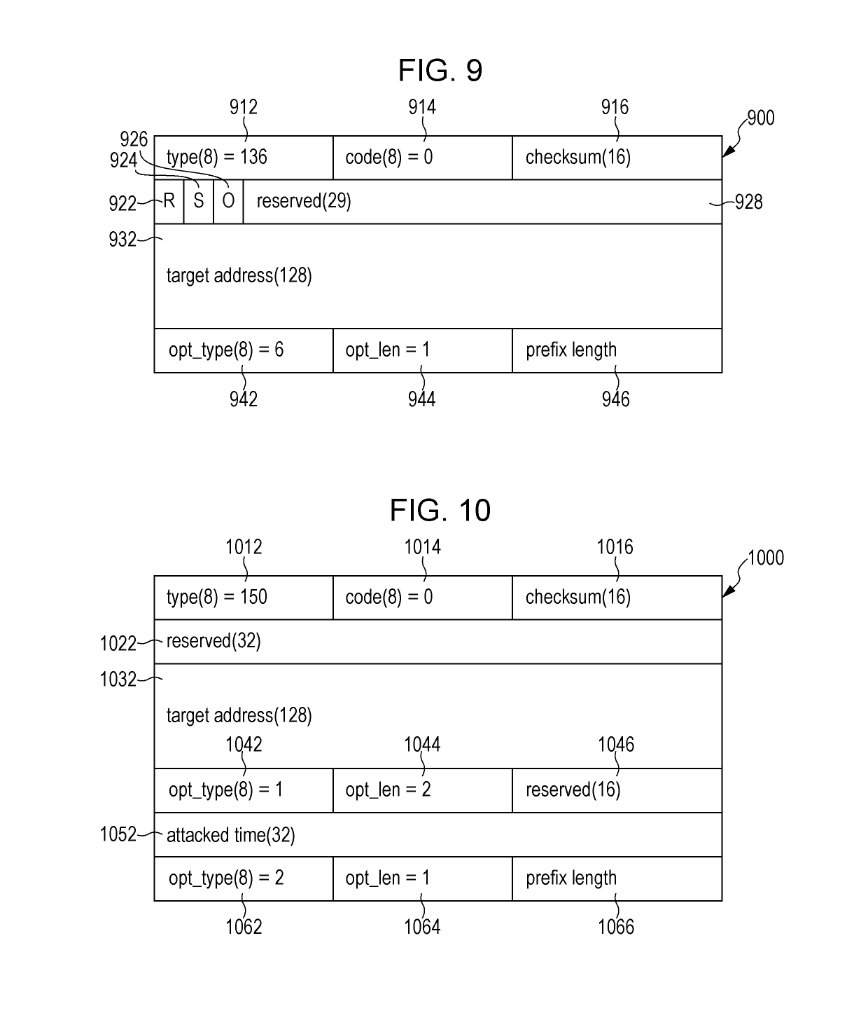

For example, an attacked address advertisement packet (ICMPv6 proprietary extension) 900 indicating the content of a neighbor advertisement (DAD) is used. FIG. 9 illustrates an example of the data structure of the attacked address advertisement packet (ICMPv6 proprietary extension) 900. The attacked address advertisement packet (ICMPv6 proprietary extension) 900 includes type 912, code 914, checksum 916, R 922, S 924, O 926, reserved 928, target address 932, opt_type 942, opt_len 944, and prefix length 946. An extension added to IPv6 in this exemplary embodiment includes the opt_type 942, the opt_len 944, and the prefix length 946. The type 912 indicates the message type (136) of a neighbor advertisement. The code 914 is a value indicating the subtype of the message type. The target address 932 indicates an IPv6 address for neighbor advertisement. The opt_type 942 indicates a type number (for example, newly added option: 6) of an option specifying added information for neighbor discovery. The prefix length 946 indicates a prefix length for preventing addresses in the same range as the attacked address from being assigned.

The other terminal having received the neighbor advertisement (together with a range of the attacked address) requests an address not in the range of the attacked address upon the next address request (upon calculating a temporary address again).

For example, in the case where the attacker uses a method of attacking terminals while shifting the address of the attack target by one each time, the next address to be attacked is highly likely to be around the attacked address. Accordingly, the other terminal does not need to transmit a neighbor solicitation in order to determine an address, and thus determines an address quickly.

The duplicate detecting module 140 is connected to the communication module 110 and the address blacklist 150. Upon receiving a request for an address change from another terminal 100 connected to the same communication line, the duplicate detecting module 140 determines whether the requested address matches the address of the terminal 100 or the attacked address stored in the address blacklist 150. Then, if a match is found, the duplicate detecting module 140 transmits a neighbor advertisement to the other terminal 100 via the communication module 110. More specifically, the duplicate detecting module 140 determines whether the target address included in the neighbor solicitation from the other terminal 100 is the same as the address registered in the address blacklist 150, and determines whether the target address is the same as the currently set IP address. If there is the same address, the duplicate detecting module 140 transmits a neighbor advertisement via the communication module 110. Neighbor advertisement is a process of notifying the other terminal 100 not to use the specified address (the address of the terminal 100 and the address on the address blacklist 150 of the terminal 100).

Note that the address changing module 130 requests the other terminal 100 connected to the same communication line for an address (an address different from the attacked address). If the requested address is used by the other terminal 100 or is the attacked address used when the other terminal 100 was attacked (the address stored in an address blacklist 150 of the other terminal 100), the other terminal 100 transmits a neighbor advertisement. Thus, the terminal 100 becomes unable to change its address to the requested address.

FIG. 2 illustrates an example of the system configuration to which this exemplary embodiment is applied.

A terminal 100A is connected to a router 210. A terminal 100B is connected to the router 210. The router 210 is connected to the terminals 100A and 100B, and is also connected to the attacker terminal 250 via a communication line 290. The attacker terminal 250 is connected to the router 210 via the communication line 290.

The router 210 is a communication device that interconnects a network incorporating the terminals 100 (the terminal 100A, the terminal 100B, and so on) and the communication line 290, which is the Internet.

The terminal 100A performs communication via the Internet. The terminal 100A corresponds to the terminal 100 of the example of FIG. 1. In the following description, the terminal 100A is an attacked terminal.

The attacker terminal 250 is a terminal of a malicious third party that performs an attack, such as DoS and unauthorized access, to the IP address of the terminal 100A.

In the case where the terminal 100B acquires an IP address after an attack to the terminal 100A, the terminal 100B is prevented from acquiring not only the current IP address of the terminal 100A, but also the attacked address (which is the IP address of the terminal 100A at the time of the attack, and is the IP address stored in the address blacklist 150 of the terminal 100A).

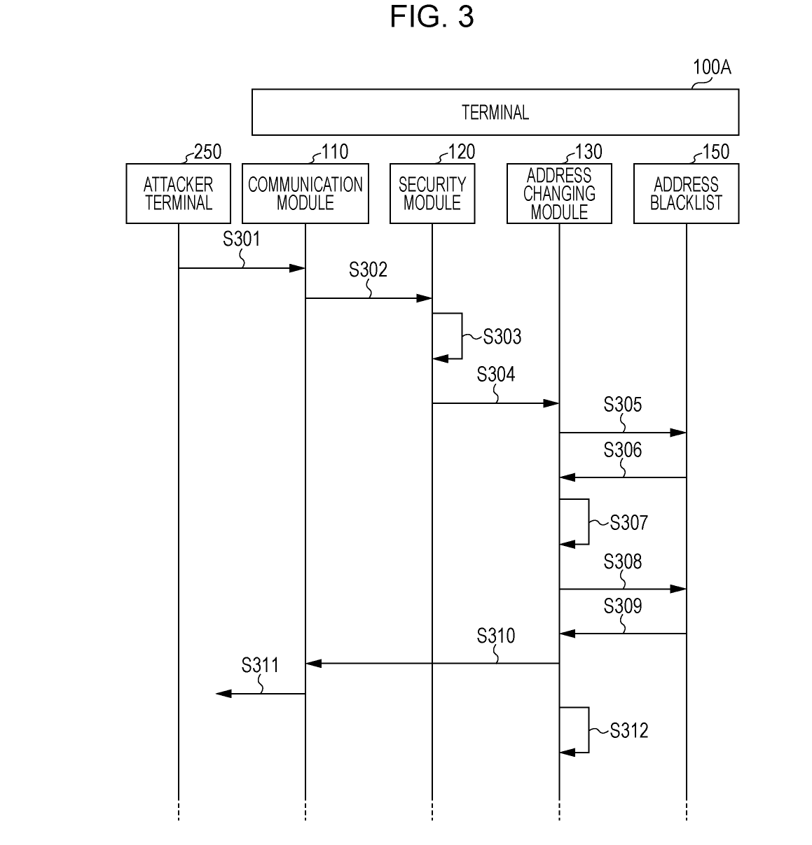

FIG. 3 is a flowchart (sequence diagram) illustrating an example of a process according to the first exemplary embodiment. More specifically, the flowchart illustrates a sequence of detecting an attack from the attacker terminal 250 and changing the address. This process is performed between the terminal 100A and the attacker terminal 250.

In step S301, the attacker terminal 250 transmits an attack packet to the terminal 100A.

In step S302, having received the packet, the communication module 110 requests the security module 120 to check whether the packet is safe in terms of security.

In step S303, having received the request for a security check, the security module 120 analyzes the packet so as to determine the safety.

If in step S303 the packet is determined to be an attack packet, then in step S304 the security module 120 requests the address changing module 130 to change the temporary address.

In steps S305 and S306, the address changing module 130 registers the temporary address before change (the attacked address) and the attacked time in the address blacklist 150.

In step S307, having received a request for the temporary address change, the address changing module 130 calculates a new temporary address.

In step S308, the address changing module 130 checks whether the newly calculated temporary address is already included in the address blacklist 150. If the calculated temporary address is not registered, then in step S309 the address changing module 130 tentatively determines the calculated temporary address as a new temporary address. If the calculated temporary address is already registered, the process returns to step S307.

In step S310, the address changing module 130 performs the regular IPv6 determination procedure. Then in step S311, the communication module 110 transmits a neighbor solicitation with the tentatively determined new temporary address as a target address, to the terminal 100B and so on.

If no neighbor advertisement is received in response to the neighbor solicitation, then in step S312 the address changing module 130 determines the temporary address as an official address. If a neighbor advertisement is received, the process returns to step S307.

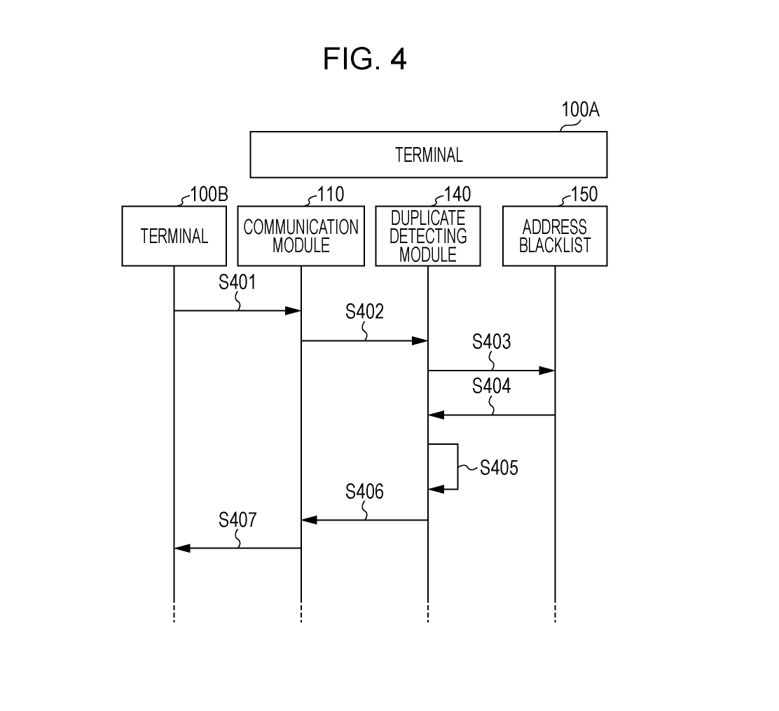

FIG. 4 is a flowchart illustrating an example of a process according to the first exemplary embodiment. More specifically, the flowchart illustrates a sequence of receiving a neighbor solicitation from another terminal (the terminal 100B), and detecting a duplicate. This process is performed between the terminal 100A and the terminal 100B. In step S401, the terminal 100B multicasts a neighbor solicitation in order to check whether there is the same IP address as the IP address that the terminal 100B is requesting. The communication module 110 of the terminal 100A receives the neighbor solicitation.

In step S402, having received the neighbor solicitation, the communication module 110 requests the duplicate detecting module 140 to check whether there is the same address as a target address included in the neighbor solicitation packet.

In steps S403 and S404, the duplicate detecting module 140 acquires a list of attacked addresses from the address blacklist 150. Note that if the address blacklist 150 contains an attacked address having an attacked time from which more than a given time period (for example, one day) has passed, the attacked address may be removed.

In step S405, the duplicate detecting module 140 determines whether the attacked address on the address blacklist 150 or the currently set temporary address is the same as the target address obtained in step S402.

If any of these addresses is the same as the target address, then in step S406 the duplicate detection module 140 instructs the communication module 110 to transmit a neighbor advertisement (DAD).

Having received an instruction for transmitting a neighbor advertisement in step S406, the communication module 110 multicasts a neighbor advertisement to the terminal 100B in step S407.

### Second Exemplary Embodiment

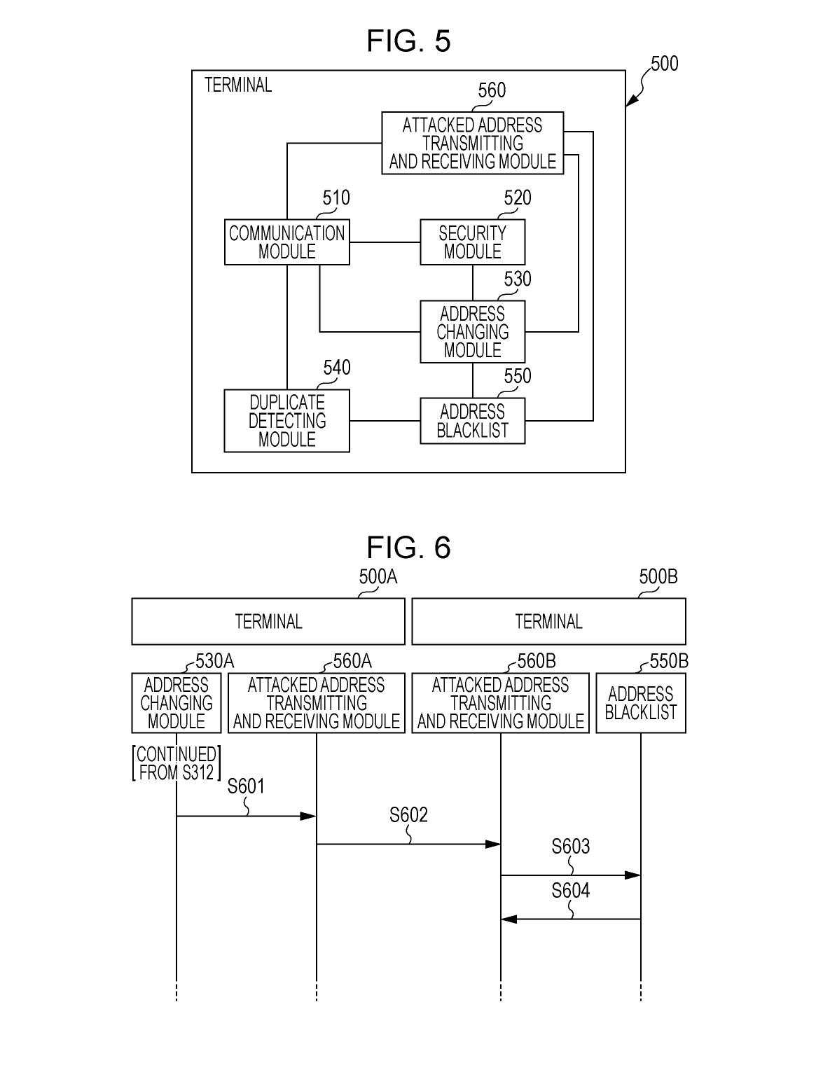

FIG. 5 is a conceptual module configuration diagram illustrating an example of the configuration of a second exemplary embodiment. The terminal 500 is configured to transmit an attacked address upon changing its address, and includes a communication module 510, a security module 520, an address changing module 530, a duplicate detecting module 540, an address blacklist 550, and an attacked address transmitting and receiving module 560. The terminal 500 is the same as the terminal 100 illustrated in the example of FIG. 1, except that the attacked address transmitting and receiving module 560 is added. The communication module 510 corresponds to the communication module 110 of the terminal 100; the security module 520 corresponds to the security module 120; the address changing module 530 corresponds to the address changing module 130; the duplicate detecting module 540 corresponds to the duplicate detecting module 140; and the address blacklist 550 corresponds to the address blacklist 150.

The communication module 510 is connected to the security module 520, the address changing module 530, the duplicate detecting module 540, and the attacked address transmitting and receiving module 560. The security module 520 is connected to the communication module 510 and the address changing module 530. The address changing module 530 is connected to the communication module 510, the security module 520, the address blacklist 550, and the attacked address transmitting and receiving module 560. The duplicate detecting module 540 is connected to the communication module 510 and the address blacklist 550. The address blacklist 550 is connected to the address changing module 530, the duplicate detecting module 540, and the attacked address transmitting and receiving module 560. The attacked address transmitting and receiving module 560 is connected to the communication module 510, the address changing module 530, and the address blacklist 550.

The attacked address transmitting and receiving module 560 transmits an attacked address to another terminal 500 connected to the same communication line, via the communication module 510. Thus, an attacked address is transmitted upon changing the address. That is, after the temporary address is changed in response to a detection of an attack, the attacked address and the attacked time are multicasted to the same link-local network (attacked address advertisement). Having received the attacked address advertisement, the other terminal 500 registers the attacked address and the attacked time included in an attacked address advertisement packet, in its address blacklist 550.

More specifically, the attacked address transmitting and receiving module 560 transmits or receives an attacked address advertisement defined as a neighbor discovery protocol of ICMPv6. When changing the attacked address, the attacked address transmitting and receiving module 560 multicasts the attacked address in accordance with the attacked address advertisement protocol. Having received the attacked address advertisement, an attacked address transmitting and receiving module 560 of the other terminal 500 registers the attacked address in its address blacklist 550.

Then, when the other terminal 500 changes its temporary address, since the attacked address is already registered in the address blacklist 550, the other terminal 500 checks in advance whether a new temporary address is already included in the address blacklist 550. Accordingly, the other terminal 500 does not need to transmit a neighbor solicitation, and thus determines an address quickly.

Note that an attacked address advertisement may include a netmask length, in addition to an attacked address and an attacked time.

The attacked address advertisement is encapsulated in an attacked address advertisement packet (ICMPv6 proprietary extension) 1000. FIG. 10 illustrates an example of the data structure of the attacked address advertisement packet (ICMPv6 proprietary extension) 1000. The attacked address advertisement packet (ICMPv6 proprietary extension) 1000 includes type 1012, code 1014, checksum 1016, reserved 1022, target address 1032, opt_type 1042, opt_len 1044, reserved 1046, attacked time 1052, opt_type 1062, opt_len 1064, and prefix length 1066. An extension added to IPv6 in this exemplary embodiment includes the opt_type 1042, the opt_len 1044, the reserved 1046, the attacked time 1052, the opt_type 1062, the opt_len 1064, and the prefix length 1066. The type 1012 indicates the type (proprietary extension number 150 is used) of an information message of ICMPv6. The code 1014 is a value indicating the subtype of the message type. The target address 1032 indicates the attacked address. The opt_type 1042 indicates the type number of the option that may be used in this message. The attacked time 1052 indicates the attacked time. The prefix length 1066 (corresponding to the prefix length 946 described above) indicates a prefix length for preventing addresses in the same range as the attacked address from being assigned.

That is, in the attacked address advertisement packet (ICMPv6 proprietary extension) 1000 of this exemplary embodiment, a new type number 150 (0×96) is tentatively set for ICMPv6, and is defined as an extension to ICMPv6.

Note that the attacked address transmitting and receiving module 560 may periodically transmit an attacked address advertisement, or may transmit an attacked address advertisement in response to an attacked address solicitation which may optionally be defined.

FIG. 6 is a flowchart illustrating an example of a process according to the second exemplary embodiment. In this flowchart, the communication module 510 is omitted. This process is performed between a terminal 500A and a terminal 500B (corresponding to the terminal 100B including an attacked address transmitting and receiving module 560B), and is performed after the process in the flowchart illustrated in the example of FIG. 3.

In step S601, an address changing module 530A having changed its temporary address transmits the attacked address and the attacked time to an attacked address transmitting and receiving module 560A, and instructs the attacked address transmitting and receiving module 560A to transmit an attacked address advertisement.

In step S602, the attacked address transmitting and receiving module 560A multicasts the attacked address advertisement to the same network.

In steps S603 and S604, having received the attacked address advertisement, an attacked address transmitting and receiving module 560B of the terminal 500B registers the attacked address and the attacked time included in the attacked address advertisement packet in an address blacklist 550B.

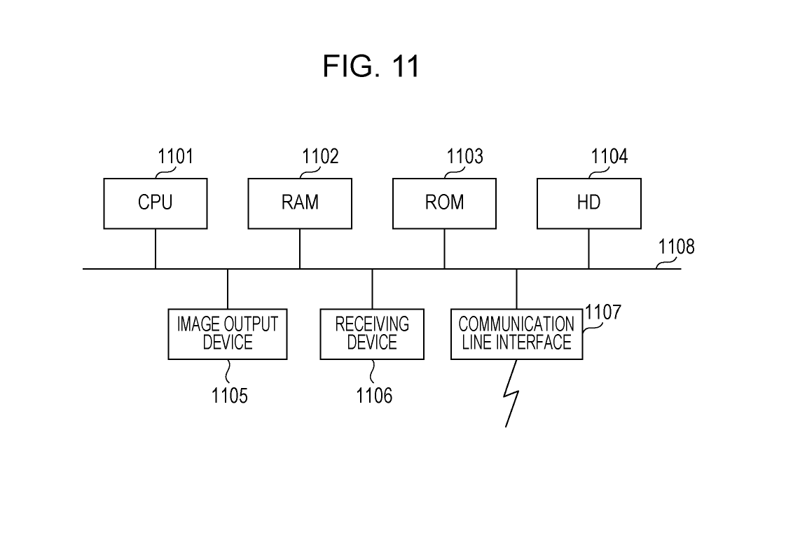

The computer (the terminal 100, and the terminal 500) that executes a program implementing the exemplary embodiments has the same hardware configuration as a general computer as illustrated in FIG. 11. More specifically, the computer is a personal computer or a computer serving as a server. For example, the computer uses a CPU 1101 as a processing unit (an arithmetic unit), and uses a RAM 1102, a ROM 1103, and an HD 1104 as storage devices. The HD 1104 may be, for example, a hard disk. The computer includes the CPU 1101 that executes programs, such as the communication module 110, the security module 120, the address changing module 130, the duplicate detecting module 140, the communication module 510, the security module 520, the address changing module 530, the duplicate detecting module 540, and the attacked address transmitting and receiving module 560. The computer further includes the RAM 1102 storing such programs and data; the ROM 1103 storing a program for starting the computer; the HD 1104 as an auxiliary storage device (or a flash memory or the like); a receiving device 1106 that receives data in response to an operation performed on a keyboard, a mouse, or a touch panel by the user; an image output device 1105 such as a cathode ray tube (CRT) or a liquid-crystal display (LCD); a communication line interface 1107 such as a network interface card for connection with a communication network; and a bus 1108 interconnecting these components for data exchange. Two or more of such computers may be connected to each other via a network.

As for the computer program implementing the foregoing exemplary embodiments, the computer program as software is read by a system having the above-described hardware configuration, and thus the exemplary embodiments are realized by the software and hardware resources in cooperation with each other.

The hardware configuration illustrated in FIG. 11 is an example only. The exemplary embodiments are not limited to the configuration illustrated in FIG. 11, and may be configured in any manner as long as the modules described in the exemplary embodiments are executable. For example, some modules may be configured as dedicated hardware (for example, application specific integrated circuit (ASIC) or the like), or some modules may be installed in an external system and be connected via a communication line. Alternatively, plural systems, each being the system illustrated in FIG. 11, may be connected to each other via a communication line so as to operate in cooperation with each other. Alternatively, the modules may be integrated into apparatuses other than a personal computer, such as home information appliance, a copying machine, a facsimile machine, a scanner, a printer, or a multifunction apparatus (an image processing apparatus having two or more of a scanner function, a printer function, a copying function, a facsimile function, and the like).

The above-described program may be provided by being stored in a recording medium or by a communication unit. In this case, for example, the above-described program may be recognized as an invention of a “computer readable recording medium having a program recorded therein”.

The “computer readable recording medium having a program recorded therein” is a computer readable recording medium storing a program and used for installation, execution, or distribution of the program.

Examples of the recording medium include, for example, digital versatile discs (DVDs), such as a DVD-R, a DVD-RW, and a DVD-RAM which are based on the standard designed by the DVD forum, and such as a DVD+R and a DVD+RW which are based on the standard designed by DVD+RW. Examples of the recording medium also include compact discs (CDs), such as a CD-ROM, a CD recordable (CD-R), and a CD rewritable (CD-RW). Examples of the recording medium also include a Blu-ray (registered trademark) Disc, a magneto-optical disc (MO), a flexible disk (FD), a magnetic tape, a hard disk, a read only memory (ROM), an electrically erasable and programmable ROM (EEPROM (registered trademark)), a flash memory, a random access memory (RAM), and a secure digital memory card (SD memory card).

The above-described program or part of the program may be recorded on the recording medium so as to be stored or distributed. Alternatively, the program or part of the program may be transmitted via a wired network used for a local area network (LAN), a metropolitan area network (MAN), a wide area network (WAN), the Internet, an intranet, or an extranet, or may be transmitted via a wireless communication network. Furthermore, the program or part of the program may be transmitted using a transmission medium including a combination of the foregoing media, or may be transmitted using carrier waves.

Furthermore, the foregoing program may be part of another program, and may be recorded on a recording medium together with another program. Also, the program may be divided and recorded on multiple recording media. The program may be recorded in any form such as a compressed form or an encrypted form, as long as the program may be decompressed or decrypted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detector that detects an attack performed via a communication line; and
a changing unit that changes a current attacked address of the information processing apparatus to an address different from the current attacked address if the attack is detected by the detector.

2. The information processing apparatus according to claim 1, further comprising:
a memory controller that controls a memory to store the attacked address;
a determining unit that determines, upon receiving a request for an address change from another information processing apparatus connected to the communication line to which the information communication apparatus is connected, whether a requested address matches the address of the information processing apparatus or the attacked address stored in the memory; and
a transmitting unit that transmits a neighbor advertisement to the other information processing apparatus if the determining unit determines that the requested address matches the address of the information processing apparatus or the attacked address.

3. The information processing apparatus according to claim 2, wherein:
the memory controller masks the attacked address and causes the memory to store the attacked address; and
the determining unit masks the requested address and determines whether the requested address matches the address stored in the memory.

4. The information processing apparatus according to claim 2, wherein the transmitting unit transmits the neighbor advertisement together with a range of the attacked address, to the other information processing apparatus.

5. The information processing apparatus according to claim 1, further comprising:
another transmitting unit that transmits the attacked address to another information processing apparatus connected to the communication line to which the information communication apparatus is connected.

6. An information processing method comprising:
detecting an attack performed via a communication line; and
changing a current attacked address of an information processing apparatus to an address different from the current attacked address if the attack is detected in the detecting.

7. A non-transitory computer readable medium storing a program causing a computer to execute a process for information processing, the process comprising:
detecting an attack performed via a communication line; and
changing a current attacked address of an information processing apparatus to an address different from the current attacked address if the attack is detected in the detecting.
